(19) United States
(12) Patent Application Publication
(10) Pub. No.: US 2017/0124794 A1
(43) Pub. Date: May 4, 2017

(54) COIN PROCESSING APPARATUS

(71) Applicant: NIPPON CONLUX CO., LTD., Sakado-shi, Saitama-ken (JP)

(72) Inventor: Naoki KATAGIRI, Sakado-shi (JP)

(73) Assignee: NIPPON CONLUX CO., LTD., Sakado-shi, Saitama-ken (JP)

(21) Appl. No.: 15/128,276

(22) PCT Filed: Dec. 12, 2014
(86) PCT No.: PCT/JP2014/083020

§ 371 Date: Sep. 22, 2016

(30) Foreign Application Priority Data
Mar. 24, 2014 (JP) 2014-059908

(51) Int. Cl. G07D 1/02; G07D 9/06; G07D 9/00

(52) U.S. Cl. CPC G07D 1/02; G07D 9/002; G07D 9/06

(57) ABSTRACT

A coin processing apparatus including a coin identification unit, a coin sort unit, a plurality of coin tubes, a coin payment unit, an initial replenishment coin tube storing coins of a predetermined initial replenishment coin number in an initial replenishment state, an increase coin tube not storing the coins in the initial replenishment state, and an initial replenishment state setting unit causing an apparatus body to recognize the initial replenishment state. The coin sort unit sorts the coins of the initial replenishment coin number into the initial replenishment coin tube and sorts coins more than the coins corresponding to the initial replenishment coin number into the increase coin tube. The coin payment unit pays the coins preferentially from the increase coin tube.

### TECHNICAL FIELD

The present invention relates to a coin processing apparatus that is mounted on a vending machine, a change machine, a fare adjustment machine, a ticket vending machine, a service apparatus, and the like (hereinafter, referred to as the “vending machine”).

### BACKGROUND ART

Conventionally, a coin processing apparatus that discriminates authenticity of input coins, sorts the input coins regarded as specie for each coin type, stores the coins, and pays the sorted and stored coins according to an amount of change is mounted in a vending machine and the like. FIG. 14 is a schematic diagram of the coin processing apparatus.

A coin processing apparatus 1 mainly includes a coin sort device 2 that discriminates authenticity of input coins and sorts the input coins for each coin type and a coin payment device 3 that stores the input coins sorted by the coin sort device 2 for each coin type, selects the coins according to an amount of change therefrom, and pays the coins. In addition, the coin sort device 2 has a coin identification unit 4 that discriminates the authenticity and the coin types of the input coins and a coin sort unit 5 that sorts the coins regarded as true coins by the coin identification unit 4 for each coin type. The coin sort unit 5 also performs sorting into a safe outside the coin processing apparatus 1 (hereinafter, referred to as the “safe”) or a return slot. In addition, the coin payment device 3 has a coin storage unit 6 that includes a plurality of coin tubes 61 to 65 storing the coins sorted by the coin sort device 2 for each coin type and a coin payment unit 7 that selects the coins according to an amount of change from the coin storage unit 6 including the plurality of coin tubes 61 to 65 and pays the coins. As the coin payment unit 7, a unit that draws the coins stored in the coin tubes 61 to 65 from slit-like holes formed in lowermost portions of the coin tubes 61 to 65 one by one by a slide member called a payout slide and pays the coins is widely adopted. In the payout slide, coin storage holes are provided in portions corresponding to the lowermost portions of the individual coin tubes 61 to 65 and the coins stored in the coin storage holes are drawn. In addition, the coin payment unit 7 selectively performs supporting of bottom surfaces of the coins stored in the coin storage holes of the payout slide and releasing thereof by the slide member called a change slide and controls payment and non-payment of the drawn coins. In addition, in the coin payment device 3, the coin container 6 generally becomes a cassette detachable from a body of the coin processing apparatus 1 to facilitate extraction of the coins when the coins in the coin payment device 3 are collected as sales.

In an operation of a vending machine and the like, it is necessary to regularly perform collection of the coins from the coin processing apparatus and replenishment of the coins for the coin processing apparatus. For the collection of the coins and the replenishment of the change, the coin processing apparatus according to the related art generally has the following two types of change management functions. First, a first type of change management function (automatic change adjustment function) allows a worker who performs the collection of the coins and the replenishment of the change (hereinafter, referred to the “worker”) to know the number of coins stored in the coin storage unit. This change management function is generally provided at a body side of the vending machine and the like and at the time of first change replenishment, the worker operates a remote control of main control of the vending machine and the like and sets an initial replenishment coin number of change. Then, the worker can confirm the number of coins stored in the coin storage unit and an increase/decrease from the initial replenishment coin number of the change, from a display unit provided in the remote control of the main control of the vending machine. Next, a second type of change management function (simplified automatic change adjustment function) does not allow the worker to know the number of coins stored actually in the coin storage unit. However, the second type of change management function enables the work to be simplified as compared with the first type of change management function. This change management function is generally provided in the coin processing apparatus and the worker causes the coin processing apparatus to recognize replenishment of the coins of the initial replenishment coin number of the change, at the time of first change replenishment. The recognition by the coin processing apparatus is generally performed automatically at the time of an attachment/detachment operation of the cassette to be the coin storage unit. Then, the increase/decrease from the initial replenishment coin number of the change is counted. In the second type of change management function, the number of coins stored actually in the coin storage unit cannot be grasped.

However, because it is not necessary to set the initial replenishment coin number of the change, the work is easy as compared with the first type of change management function.

The work for the collection of the coins and the replenishment of the change using the two change management functions is as follows. First, the collection of the coins is performed by paying the coins more than the coins corresponding to the initial replenishment coin number of the change by the coin payment unit of the coin processing apparatus. Next, the replenishment of the change is performed by inputting the coins corresponding to the decrease from the initial replenishment coin number of the change from a slot of the coin processing apparatus. In the replenishment of the change, when the coins more than the coins corresponding to the decrease from the initial replenishment coin number of the change are input, the coins more than the coins corresponding to the initial replenishment coin number of the change are turned to the return slot.

### CITATION LIST

### Patent Literature

Patent Literature 1: JP 63-236190 A
Patent Literature 2: JP 1-112392 A

### SUMMARY OF INVENTION

### Technical Problem

In the change management functions according to the related art described above, the collection of the coins corresponding to the increase from the initial replenishment coin number of the change is performed by the coin payment unit of the coin processing apparatus. However, considerable time is necessary for paying the coins by the coin payment unit. In addition, in the change management functions according to the related art described above, because the replenishment of the change is performed by inputting the coins from the slot of the coin processing apparatus, considerable time and effort are necessary for the replenishment of the change. As such, the considerable time and effort are necessary for the work for the collection of the coins and the replenishment of the change using the change management functions in the related art. For this reason, in actual work for the collection of the coins and the replenishment of the change, the worker does not use the change management functions, draws a line by a permanent marker at a point of a height of a coin tube corresponding to the initial replenishment coin number of the change, and extracts the coins directly from the coin storage unit to the line or replenishes the change to the line by manual work.

An object of the present invention is to provide a coin processing apparatus that can perform collection of coins and replenishment of change by manual work in short time.

### Solution to Problem

In order to solve the above problem, the coin processing apparatus according to claim 1 is the coin processing apparatus that includes a coin identification unit identifying types of input coins, a coin sort unit sorting the coins identified by the coin identification unit for each coin type, a plurality of coin tubes storing the coins sorted by the coin sort unit for each coin type, and a coin payment unit paying the coins stored in the coin tubes, the coin processing apparatus comprising: an initial replenishment coin tube and an increase coin tube that are provided for at least one specific coin type, the initial replenishment coin tube storing coins of a predetermined initial replenishment coin number in an initial replenishment state in which work for collection of the coins and replenishment of change is performed and the increase coin tube not storing the coins in the initial replenishment state; and an initial replenishment state setting unit that causes an apparatus body to recognize the initial replenishment state, wherein, when the number of coins stored in the initial replenishment coin tube is smaller than the initial replenishment coin number, the coin sort unit sorts the input coins of the specific coin type into the initial replenishment coin tube and when the number of coins stored in the initial replenishment coin tube is the initial replenishment coin number, the coin sort unit sorts the input coins of the specific coin type into the increase coin tube, and when the coins are stored in the increase coin tube, the coin payment unit pays the coins of the specific coin type from the increase coin tube and when no coin is stored in the increase coin tube, the coin payment unit pays the coins of the specific coin type from the initial replenishment coin tube.

The coin processing apparatus according to claim 2 is the coin processing apparatus according to claim 1, wherein the initial replenishment state setting unit is an input unit provided in the apparatus body and a worker performs an input manually using the initial replenishment state setting unit.

The coin processing apparatus according to claim 3 is the coin processing apparatus according to claim 1 or 2, further comprising: a coin tube state display unit that displays a storage state of the coins in each of the coin tubes.

The coin processing apparatus according to claim 4 is the coin processing apparatus according to claim 3, wherein the coin tube state display unit displays whether the coins of the initial replenishment coin number are stored in the initial replenishment coin tube and whether the coins are stored in the increase coin tube.

The coin processing apparatus according to claim 5 is the coin processing apparatus according to claim 3, wherein the coin tube state display unit displays an increase/decrease amount of the number of stored coins from the initial replenishment state.

### Advantageous Effect of Invention

According to the present invention, collection of coins and replenishment of change in a coin processing apparatus can be performed in short time.

### BRIEF DESCRIPTION OF DRAWINGS

FIG. 1 is a block diagram of a coin processing apparatus according to an embodiment of the present invention.

FIG. 2 is a schematic diagram of the coin processing apparatus according to the embodiment of the present invention.

FIG. 3 is a flowchart illustrating a flow of an operation of the coin processing apparatus according to the embodiment of the present invention.

FIG. 4 is a flowchart illustrating a flow of sort processing of the coin processing apparatus according to the embodiment of the present invention.

FIG. 5 is a flowchart illustrating a flow of 1 Yuan sort processing of the coin processing apparatus according to the embodiment of the present invention.

FIG. 6 is a flowchart illustrating a flow of 5 Jiao sort processing of the coin processing apparatus according to the embodiment of the present invention.

FIG. 7 is a flowchart illustrating a flow of payment processing of the coin processing apparatus according to the embodiment of the present invention.

FIG. 8 is a flowchart illustrating a flow of payment tube determination processing of the coin processing apparatus according to the embodiment of the present invention.

FIG. 9 is a flowchart illustrating a flow of 1 Yuan payment tube selection processing of the coin processing apparatus according to the embodiment of the present invention.

FIG. 10 is a flowchart illustrating a flow of 5 Jiao payment tube selection processing of the coin processing apparatus according to the embodiment of the present invention.

FIG. 11 is a flowchart illustrating a flow of initial replenishment state setting processing of the coin processing apparatus according to the embodiment of the present invention.

FIG. 12 is a flowchart illustrating a flow of coin tube state display processing of the coin processing apparatus according to the embodiment of the present invention.

FIG. 13 is a schematic diagram of another embodiment of a coin tube state display unit according to the present invention.

FIG. 14 is a schematic diagram of a coin processing apparatus according to the related art.

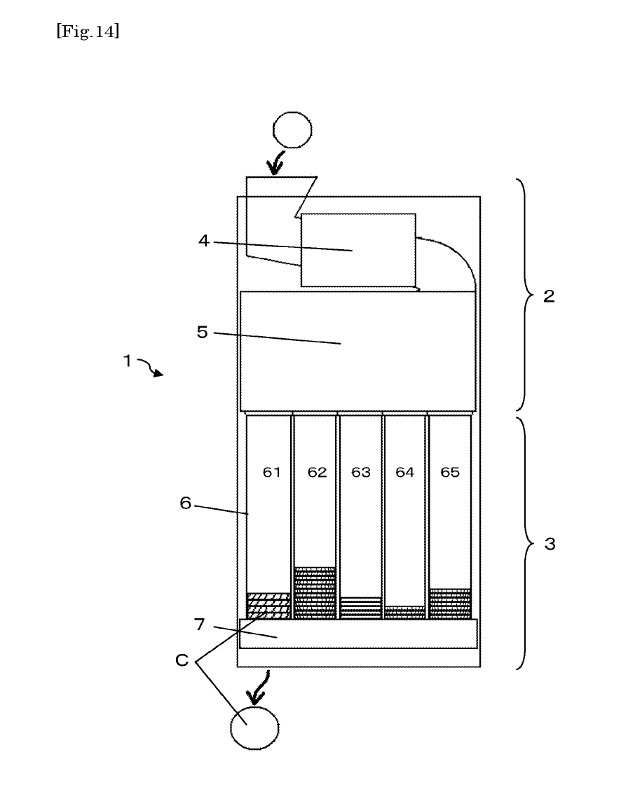

### DESCRIPTION OF EMBODIMENTS

Hereinafter, an embodiment of the present invention will be described on the basis of the drawings.

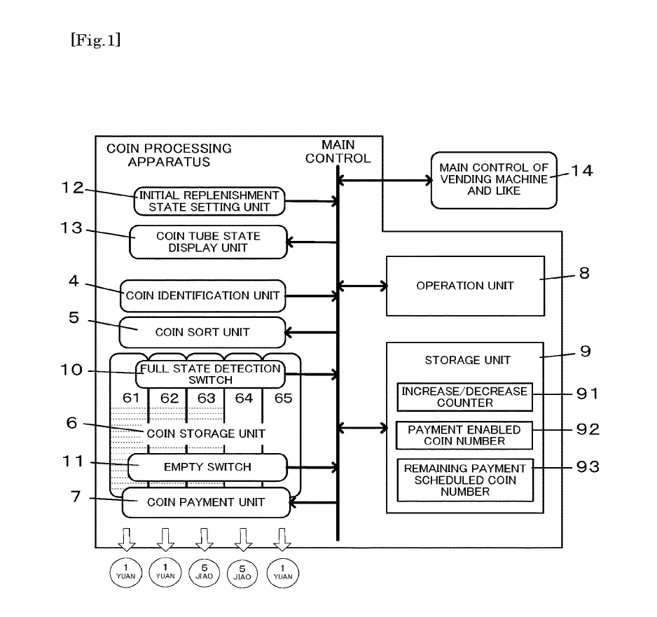

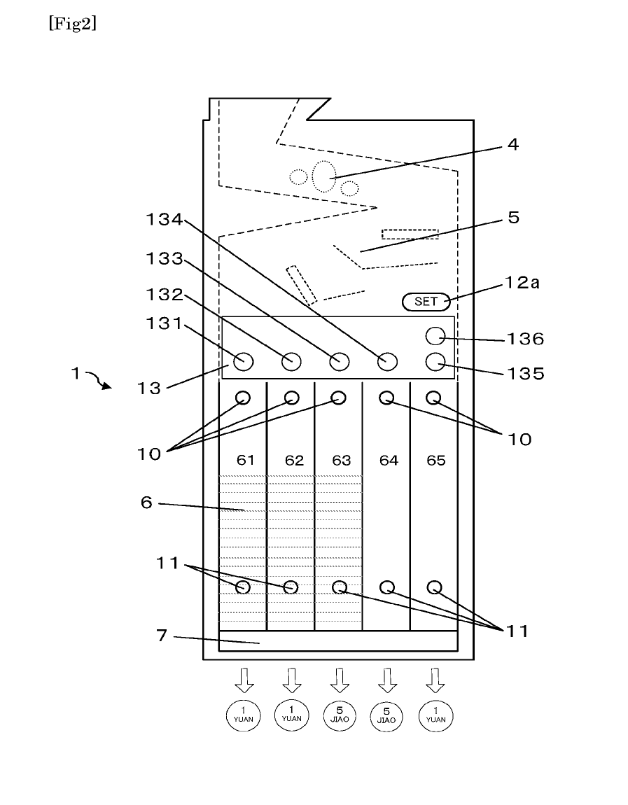

FIG. 1 is a block diagram of a coin processing apparatus 1 according to an embodiment of the present invention. FIG. 2 is a schematic diagram of the coin processing apparatus 1 according to the embodiment of the present invention and schematically illustrates the coin processing apparatus 1. A structure of the coin processing apparatus 1 according to the embodiment is the same as a structure of a coin processing apparatus according to the related art described above, except for a portion to be described below. Therefore, the same components as components in the coin processing apparatus according to the related art described above among components in this embodiment are denoted with the same reference numerals and detailed description thereof is omitted.

The coin processing apparatus 1 has a coin identification unit 4, a coin sort unit 5, a coin storage unit 6 including five coin tubes 61 to 65, a coin payment unit 7, an operation unit 8, and a storage unit 9. The coin payment unit 7 has one payout slide provided with five coin storage holes corresponding to the individual coin tubes 61 to 65 and pays coins stored in the coin storage holes by drawing the payout slide. A full state detection switch 10 to be a sensor to detect that each of the coin tubes 61 to 65 is full of the coins and an empty switch 11 to be a sensor to detect that the number of coins stored in each of the coin tubes 61 to 65 becomes a predetermined number or less are provided in each of the coin tubes 61 to 65.

The coin processing apparatus 1 further has an increase/decrease counter 91 of each of the coin tubes 61 to 65 provided in the storage unit 9, to grasp the number of coins stored in each of the coin tubes 61 to 65. An initial value of the increase/decrease counter 91 when power is supplied is 0. In the increase/decrease counter 91, addition is performed when the coins are sorted into each of the coin tubes 61 to 65 and subtraction is performed when the coins are paid from each of the coin tubes 61 to 65.

In addition, the storage unit 9 of the coin processing apparatus 1 has an area to store a payment enabled coin number 92 and a remaining payment scheduled coin number 93 of each of the coin tubes 61 to 65 necessary for processing after receiving a repayment command from a main control 14 of a vending machine and the like. The payment enabled coin number 92 is the number of coins that can be surely paid from each of the coin tubes 61 to 65, which is recognized by the coin processing apparatus 1. For the payment enabled coin number 92, when power of an apparatus body is supplied or attachment/detachment of a cassette of the coin storage unit 6 including the coin tubes 61 to 65 is recognized, counting starts from 0, in the case in which it is detected by the empty switch 11 that the number of coins stored in each of the coin tubes 61 to 65 is the predetermined number or less, and measurement starts from a number obtained by adding 1 to the predetermined number, in the case in which it is not detected by the empty switch 11 that the number of coins stored in each of the coin tubes 61 to 65 is the predetermined number or less. Basically, addition is performed when the coins are sorted into each of the coin tubes 61 to 65 and subtraction is performed when the coins are paid from each of the coin tubes 61 to 65. During a period in which it is not detected by the empty switch 11 that the number of coins stored in each of the coin tubes 61 to 65 is the predetermined number or less, the payment enabled coin number 92 in which subtraction is not performed in the case of the predetermined number or less becomes a number of coins in a full state, when the full state is detected by the full state detection sensor 10. The number of coins that can be surely paid from each of the coin tubes 61 to 65, that is, the minimum storage number of coins that are stored in each of the coin tubes 61 to 65 can be grasped by the payment enabled coin number 92.

The configuration described above is the same configuration as the configuration of the coin processing apparatus according to the related art.

The five coin tubes 61 to 65 of the coin processing apparatus 1 correspond to an A tube (1 Yuan) 61 in which 1 Yuan coins are stored, a B tube (1 Yuan) 62 in which 1 Yuan coins are stored, a C tube (5 Jiao) 63 in which 5 Jiao coins are stored, a D tube (5 Jiao) 64 in which 5 Jiao coins are stored, and a D tube (1 Yuan) 65 in which 1 Yuan coins are stored, which are disposed from the left side of FIGS. 1 and 2. The five coin tubes 61 to 65 are divided into initial replenishment coin tubes and increase coin tubes. The initial replenishment coin tubes store coins of a predetermined initial replenishment coin number in an initial replenishment state in which work for collecting the coins and replenishing change is performed. Coins input only when the number of coins stored in the initial replenishment coin tubes is smaller than the initial replenishment coin number are sorted into the initial replenishment coin tubes. The increase coin tubes do not store the coins in the initial replenishment state in which the work for collecting the coins and replenishing the change is performed. When the coins of the initial replenishment coin number are stored in the initial replenishment coin tubes, the coins more than the coins corresponding to the initial replenishment coin number are sorted into the increase coin tubes. In the coin processing apparatus 1, the A tube (1 Yuan) 61, the B tube (1 Yuan) 62, and the C tube (5 Jiao) 63 are the initial replenishment coin tubes and the D tube (5 Jiao) 64 and the E tube (1 Yuan) 65 are the increase coin tubes.

In the coin processing apparatus 1, an initial replenishment state setting unit 12 not provided in the coin processing apparatus according to the related art is provided. The initial replenishment state setting unit 12 is a unit to cause the coin processing apparatus 1 to recognize the initial replenishment state in which the work for collecting the coins and replenishing the change is performed. The coin processing apparatus 1 includes a SET button 12a as the initial replenishment state setting unit 12. At the time of beginning selling in a vending machine and the like, a worker stores the coins of the predetermined initial replenishment coin number in the initial replenishment coin tubes and stores no coin in the increase coin tubes. Then, the worker presses the SET button 12a and causes the coin processing apparatus 1 to recognize the initial replenishment state. If the SET button 12a is pressed, values of the increase/decrease counters 91 of all of the coin tubes 61 to 65 are cleared and become 0. That is, in the initial replenishment state, the values of the increase/decrease counters 91 of all of the coin tubes 61 to 65 become 0. Then, an increase/decrease amount of the coins stored in each of the coin tubes 61 to 65 from the initial replenishment state can be grasped by referring to the value of the increase/decrease counter 91 of each of the coin tubes 61 to 65.

In addition, the initial replenishment state setting unit 12 according to the present invention may cause the coin processing apparatus to recognize the initial replenishment state automatically at the time of an attachment/detachment operation of the cassette to be the coin storage unit 6 with respect to the body of the coin processing apparatus 1. However, in a configuration in which the worker causes the coin processing apparatus 1 to recognize the initial replenishment state manually using an input unit, like the SET button 12a, when the cassette to be the coin storage unit is attached/detached to perform only maintenance of the coin processing apparatus 1, the value of the increase/decrease counter 91 of each of the coin tubes 61 to 65 is not cleared. Therefore, there is an advantage in that it is not unnecessary to perform the work for collecting the coins and replenishing the change again and cause the coin processing apparatus 1 to recognize the initial replenishment state.

In the coin processing apparatus 1, the increase/decrease counter 91 is used to grasp the increase/decrease amount of the coins stored in each of the coin tubes 61 to 65 from the initial replenishment state. However, in the coin processing apparatus according to the present invention, a special counter may be provided without using the increase/decrease counter 91. In this case, instead of the value of the increase/decrease counter 91, a value of the counter provided specially is referred to in the following processing.

The sort and the payment of the coins input in the coin processing apparatus 1 are performed as follows. First, for the sort of the input coins, in a state in which the number of coins stored in the initial replenishment coin tube is smaller than the initial replenishment coin number, that is, when the value of the increase/decrease counter 91 of the initial replenishment coin tube is smaller than 0, the coin sort unit 5 of the coin processing apparatus 1 sorts the input coins into the initial replenishment coin tube and in a state in which the number of coins stored in the initial replenishment coin tube is the initial replenishment coin number, that is, when the value of the increase/decrease counter 91 of the initial replenishment coin tube is 0, the coin sort unit 5 sorts the input coins into the increase coin tube. Next, for the payment of the coins, in a state in which the coins are stored in the increase coin tube, that is, when the value of the increase/decrease counter 91 of the increase coin tube is larger than 0, the coin payment unit 7 of the coin processing apparatus 1 pays the coins from the increase coin tube and in a state in which no coin is stored in the increase coin tube, that is, when the value of the increase/decrease counter 91 of the increase coin tube is 0, the coin payment unit 7 pays the coins from the initial replenishment coin tube.

The collection of the coins and the replenishment of the change in the coin processing apparatus 1 are performed by the manual work of the worker as follows. First, when there are the coins stored in the increase coin tube, the worker may collect all of the coins. For this reason, the number of coins does not need to be counted and the coins are sorted into coins of individual types. Therefore, the worker can collect the coins in short time without effort. When the coins are stored in the increase coin tube, the coins of the predetermined initial replenishment coin number are stored in the initial replenishment coin tube. Therefore, the worker can instantaneously determine that the replenishment of the change is unnecessary. Meanwhile, when the coins are not stored in the increase coin tube, the worker can determine that the replenishment of the change is necessary. However, even in this case, when the coins of the initial replenishment coin number are stored in the initial replenishment coin tube, the replenishment of the change is unnecessary.

In addition, a coin tube state display unit 13 that is not provided in the coin processing apparatus according to the related art and displays a storage state of the coins in each of the coin tubes 61 to 65 is provided in the coin processing apparatus 1. The coin tube state display unit 13 includes six LED lamps, which are an A lamp 131 corresponding to the A tube (1 Yuan) 61, a B lamp 132 corresponding to the B tube (1 Yuan) 62, a C lamp 133 corresponding to the C tube (5 Jiao) 63, a D lamp 134 corresponding to the D tube (5 Jiao) 64, an E lamp 135 corresponding to the E tube (1 Yuan) 65, and a safe lamp 136 corresponding to a safe, respectively. When it is necessary to replenish the initial replenishment coin tube with the coins, that is, when the number of coins stored in the initial replenishment coin tube is smaller than the initial replenishment coin number, the LED lamp corresponding to the coin tube is turned on. In addition, when it is necessary to collect the coins from the increase coin tube or the safe, that is, when the coins are stored in the increase coin tube or the coins are stored in the safe, the LED lamp corresponding to the increase coin tube or the safe is flickered. By the coin tube state display unit 13, the worker can instantaneously confirm the coin tubes 61 to 65 in which it is necessary to perform the collection of the coins or the replenishment of the change and can shorten a work time of the collection of the coins and the replenishment of the change.

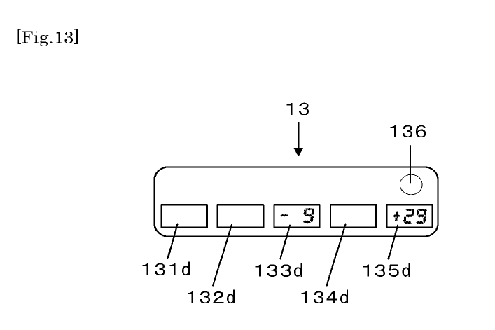

The coin tube state display unit 13 according to the present invention may allow the worker to easily recognize that the collection of the coins or the replenishment of the change needs to be performed for each of the coin tubes 61 to 65 and is not limited to the above configuration. For example, as illustrated in FIG. 13, it may be thought that an increase/decrease amount of the stored coin number from the initial replenishment state, that is, a value of the increase/decrease counter 91 for each of the coin tubes 61 to 65 is displayed. In this configuration, the number of coins which the initial replenishment coin tube needs to be replenished with and the number of coins which need to be collected from the increase coin tube can be confirmed at a glance. In an example of FIG. 13, it can be confirmed at a glance that the C tube (5 Jiao) 63 needs to be replenished with 9 coins of 5 Jiao and 29 coins of 1 Yuan need to be collected from the E tube (1 Yuan) 65.

Next, a flow of processing executed in the coin processing apparatus 1 according to the embodiment of the present invention will be described.

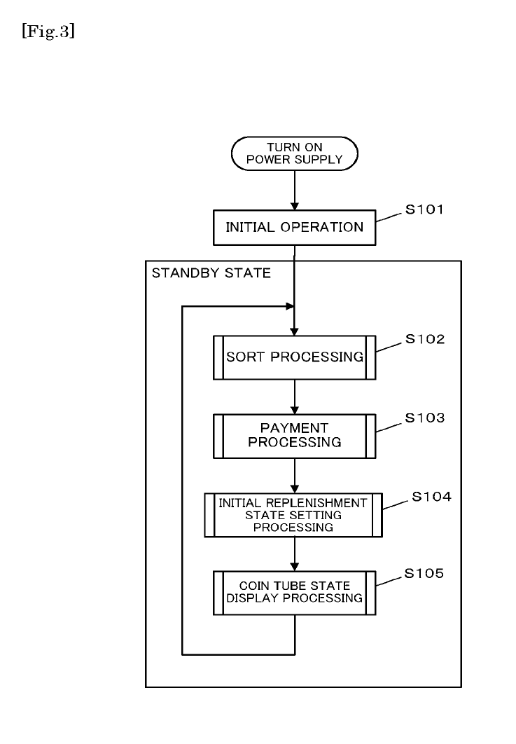

FIG. 3 is a flowchart illustrating a flow of an operation of the coin processing apparatus 1 according to the embodiment of the present invention. When power is supplied, first, the coin processing apparatus 1 executes an initial operation (S101). Then, the coin processing apparatus 1 enters a standby state and when an input of the coins is detected, the coin processing apparatus 1 executes sort processing (S102). When a repayment command is received from the main control 14 of the vending machine and the like, the coin processing apparatus 1 executes payment processing (S103). When the SET button 12a provided in the coin processing apparatus 1 is pressed, the coin processing apparatus 1 executes initial replenishment state setting processing (S104). And, the coin processing apparatus 1 executes coin tube state display processing (S105) according to the value of the increase/decrease counter 91 corresponding to each of the coin tubes 61 to 65.

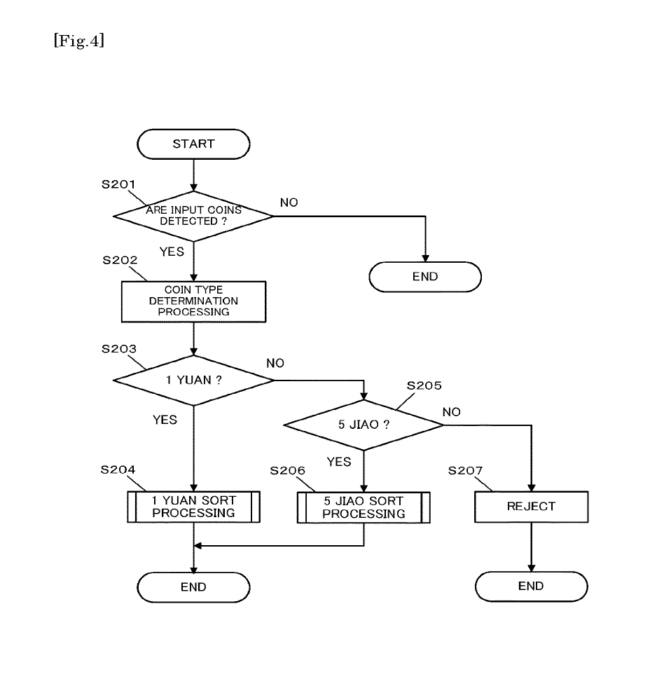

FIG. 4 is a flowchart illustrating a flow of the sort processing (S102) of the coin processing apparatus 1 according to the embodiment of the present invention. In the sort processing (S102), when the input of the coins is detected in the standby state (S201), the coin processing apparatus 1 executes coin type determination processing (S202). When it is determined that the input coins are coins of 1 Yuan (S203), the coin processing apparatus 1 executes 1 Yuan sort processing (S204). When it is determined that the input coins are coins of 5 Jiao (S205), the coin processing apparatus 1 executes 5 Jiao sort processing (S206). When it is determined that the input coins are neither coins of 1 Yuan nor coins of 5 Jiao, the coin processing apparatus 1 executes reject processing (S207) for returning the coins to a return slot.

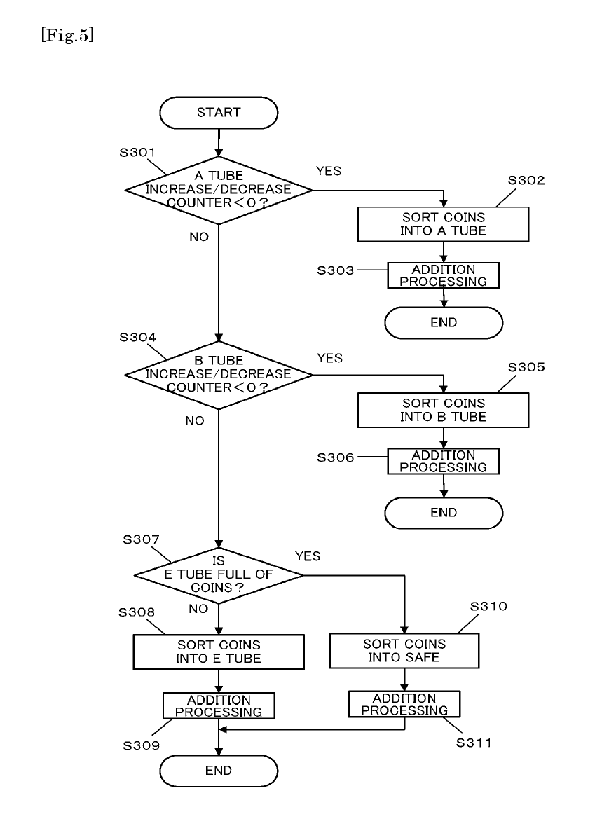

FIG. 5 is a flowchart illustrating a flow of the 1 Yuan sort processing (S204) of the coin processing apparatus 1 according to the embodiment of the present invention. In the 1 Yuan sort processing (S204), first, the coin processing apparatus 1 determines whether the value of the increase/decrease counter 91 of the A tube (1 Yuan) 61 to be the initial replenishment coin tube is smaller than 0 (S301). When the value of the increase/decrease counter 91 of the A tube (1 Yuan) 61 is smaller than 0, the coin processing apparatus 1 sorts the input coins into the A tube (1 Yuan) 61 (S302), executes addition processing (S303) such as updating of the increase/decrease counter 91 and the payment enabled coin number 92 corresponding to the A tube (1 Yuan) 61, and ends the 1 Yuan sort processing (S204). When the value of the increase/decrease counter 91 of the A tube (1 Yuan) 61 is 0, the coin processing apparatus 1 determines whether the value of the increase/decrease counter 91 of the B tube (1 Yuan) 62 to be another initial replenishment coin tube is smaller than 0 (S304). When the value of the increase/decrease counter 91 of the B tube (1 Yuan) 62 is smaller than 0, the coin processing apparatus 1 sorts the input coins into the B tube (1 Yuan) 62 (S305), executes addition processing (S306) such as updating of the increase/decrease counter 91 and the payment enabled coin number 92 corresponding to the B tube (1 Yuan) 62, and ends the 1 Yuan sort processing (S204). When the value of the increase/decrease counter 91 of the B tube (1 Yuan) 62 is 0, the coin processing apparatus 1 determines whether the E tube (1 Yuan) 65 to be the increase coin tube is full of the coins (S307). When the E tube (1 Yuan) 65 is not full of the coins, the coin processing apparatus 1 sorts the input coins into the E tube (1 Yuan) 65 (S308), executes addition processing (S309) such as updating of the increase/decrease counter 91 and the payment enabled coin number 92 corresponding to the E tube (1 Yuan) 65, and ends the 1 Yuan sort processing (S204). When the E tube (1 Yuan) 65 is full of the coins, the coin processing apparatus 1 sorts the input coins into the safe (S310), executes addition processing (S311) such as updating of the increase/decrease counter 91 and the payment enabled coin number 92 corresponding to the safe, and ends the 1 Yuan sort processing (S204).

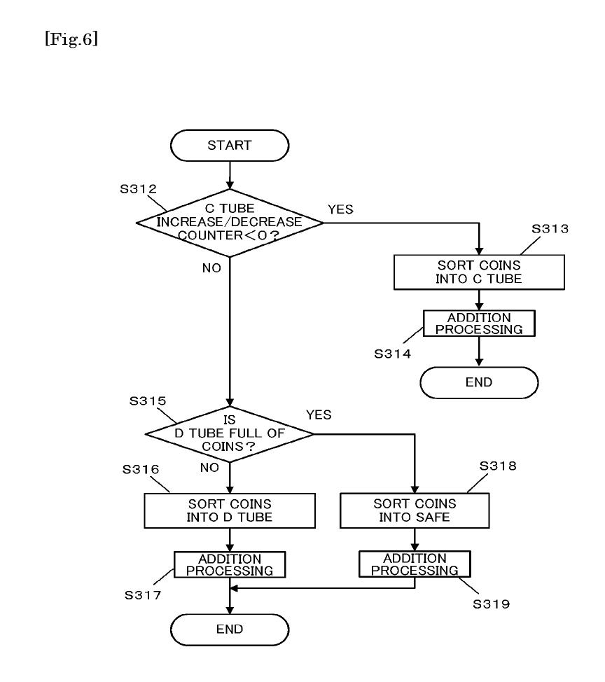

FIG. 6 is a flowchart illustrating a flow of the 5 Jiao sort processing (S206) of the coin processing apparatus 1 according to the embodiment of the present invention. In the 5 Jiao sort processing (S206), first, the coin processing apparatus 1 determines whether the value of the increase/decrease counter 91 of the C tube (5 Jiao) 63 to be the initial replenishment coin tube is smaller than 0 (S312). When the value of the increase/decrease counter 91 of the C tube (5 Jiao) 63 is smaller than 0, the coin processing apparatus 1 sorts the input coins into the C tube (5 Jiao) 63 (S313), executes addition processing (S314) such as updating of the increase/decrease counter 91 and the payment enabled coin number 92 corresponding to the C tube (5 Jiao) 63, and ends the 5 Jiao sort processing (S206). When the value of the increase/decrease counter 91 of the C tube (5 Jiao) 63 is 0, the coin processing apparatus 1 determines whether the D tube (5 Jiao) 64 to be the increase coin tube is full of the coins (S315). When the D tube (5 Jiao) 64 is not full of the coins, the coin processing apparatus 1 sorts the input coins into the D tube (5 Jiao) 64 (S316), executes addition processing (S317) such as updating of the increase/decrease counter 91 and the payment enabled coin number 92 corresponding to the D tube (5 Jiao) 64, and ends the 5 Jiao sort processing (S206). When the D tube (5 Jiao) 64 is full of the coins, the coin processing apparatus 1 sorts the input coins into the safe (S318), executes addition processing (S319) such as updating of the increase/decrease counter 91 corresponding to the safe, and ends 5 Jiao sort processing (S206).

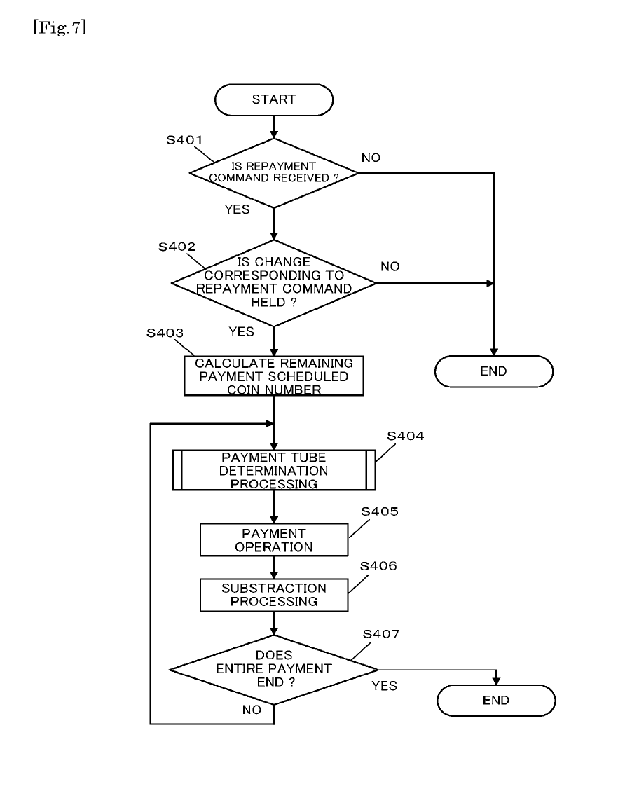

FIG. 7 is a flowchart illustrating a flow of the payment processing (S103) of the coin processing apparatus 1 according to the embodiment of the present invention. When a repayment command is received from the main control 14 of the vending machine and the like, the coin processing apparatus 1 starts the payment processing. The repayment command includes types of coins to be paid and a payment scheduled coin number as content thereof. In the payment processing (S103), when the repayment command is received from the main control 14 of the vending machine and the like (S401), the coin processing apparatus 1 determines whether change corresponding to the repayment command is held by referring to the payment enabled coin number 92 (S402). When the change corresponding to the repayment command is not held, the coin processing apparatus 1 ends the payment processing (S103). When the change corresponding to the repayment command is held, the coin processing apparatus 1 calculates the remaining payment scheduled coin number 93 (S403) and executes payment tube determination processing (S404). In the payment tube determination processing (S404), the coin processing apparatus 1 determines the coin tubes 61 to 65 that perform the payment of the coins in a next payment operation (one reciprocating operation of drawing and returning of the payout slide). Next, the coin processing apparatus 1 executes one payment operation (one reciprocating operation of drawing and returning of the payout slide) and pays the coins from the coin tubes 61 to 65 determined as the coin tubes performing the payment (S405) in the payment tube determination processing (S404). Next, the coin processing apparatus 1 executes subtraction processing such as updating of the increase/decrease counter 91 and the payment enabled coin number 92 according to the number of paid coins (S406). Next, the coin processing apparatus 1 determines whether entire payment ends (S407). When the entire payment ends, the coin processing apparatus 1 ends the payment processing (S103) and when the entire payment does not end, the coin processing apparatus 1 executes the payment tube determination processing for the remaining payment scheduled coins (S404). Hereinafter, the coin processing apparatus 1 repeats the same processing.

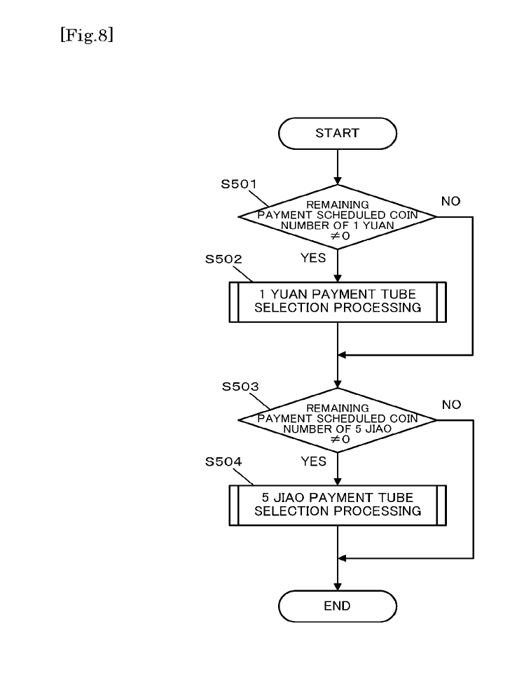

FIG. 8 is a flowchart illustrating a flow of the payment tube determination processing (S404) of the coin processing apparatus 1 according to the embodiment of the present invention. In the payment tube determination processing (S404), the coin processing apparatus 1 determines whether the remaining payment scheduled coin number 93 of 1 Yuan is 0 (S501). When the remaining payment scheduled coin number 93 of 1 Yuan is not 0, the coin processing apparatus 1 executes 1 Yuan payment tube selection processing (S502) for selecting the coin tube performing the payment of the coins of 1 Yuan. When the remaining payment scheduled coin number 93 of 1 Yuan is 0, the coin processing apparatus 1 proceeds to next processing without executing the 1 Yuan payment tube selection processing (S502). In the next processing, the coin processing apparatus 1 determines whether the remaining payment scheduled coin number 93 of 5 Jiao is 0 (S503). When the remaining payment scheduled coin number 93 of 5 Jiao is not 0, the coin processing apparatus 1 executes 5 Jiao payment tube selection processing (S504) for selecting the coin tube performing the payment of the coins of 5 Jiao. When the remaining payment scheduled coin number 93 of 5 Jiao is 0, the coin processing apparatus 1 ends the payment tube determination processing (S404) without executing the 5 Jiao payment tube selection processing (S504).

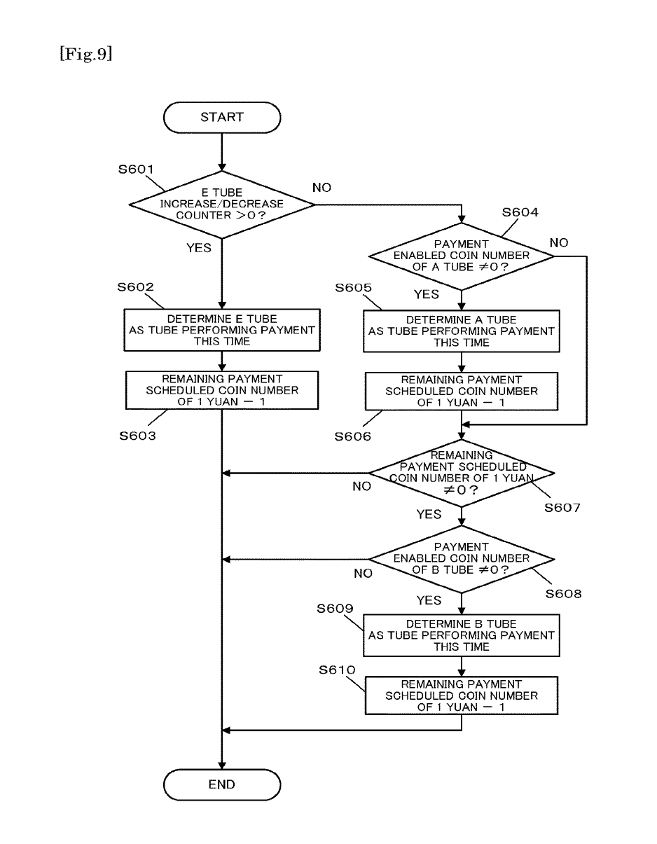

FIG. 9 is a flowchart illustrating a flow of the 1 Yuan payment tube selection processing (S502) of the coin processing apparatus 1 according to the embodiment of the present invention. In the 1 Yuan payment tube selection processing (S502), first, the coin processing apparatus 1 determines whether the value of the increase/decrease counter 91 of the E tube (1 Yuan) 65 to be the increase coin tube is larger than 0 (S601). When the value of the increase/decrease counter 91 of the E tube (1 Yuan) 65 is larger than 0, the coin processing apparatus 1 selects the E tube (1 Yuan) 65 as a coin tube performing the payment this time (S602), updates the remaining payment scheduled coin number 93 of the coins of 1 Yuan by subtracting a value thereof by 1 (S603), and ends the 1 Yuan payment tube selection processing (S502). When the value of the increase/decrease counter 91 of the E tube (1 Yuan) 65 is 0, the coin processing apparatus 1 determines whether the payment enabled coin number 92 of the A tube (1 Yuan) 61 to be the initial replenishment coin tube is 0 (S604). When the payment enabled coin number 92 of the A tube (1 Yuan) 61 is not 0, the coin processing apparatus 1 selects the A tube (1 Yuan) 61 as a coin tube performing the payment this time (S605) and updates the remaining payment scheduled coin number 93 of the coins of 1 Yuan by decreasing a value thereof by 1 (S606). When the payment enabled coin number 92 of the A tube (1 Yuan) 61 is 0, the coin processing apparatus 1 proceeds to next processing without executing this processing. In the next processing, the coin processing apparatus 1 determines whether the remaining payment scheduled coin number 93 of 1 Yuan is 0 (S607). When the remaining payment scheduled coin number 93 of 1 Yuan is 0, the coin processing apparatus 1 ends the 1 Yuan payment tube selection processing (S502). When the remaining payment scheduled coin number 93 of 1 Yuan is not 0, the coin processing apparatus 1 determines whether the payment enabled coin number 92 of the B tube (1 Yuan) 62 to be another initial replenishment coin tube is 0 (S608). When the payment enabled coin number 92 of the B tube (1 Yuan) 62 is not 0, the coin processing apparatus 1 selects the B tube (1 Yuan) 62 as a coin tube performing the payment this time (S609) and updates the remaining payment scheduled coin number 93 of the coins of 1 Yuan by decreasing a value thereof by 1 (S610). When the payment enabled coin number 92 of the B tube (1 Yuan) 62 is 0, the coin processing apparatus 1 ends the 1 Yuan payment tube selection processing (S502) without executing this processing.

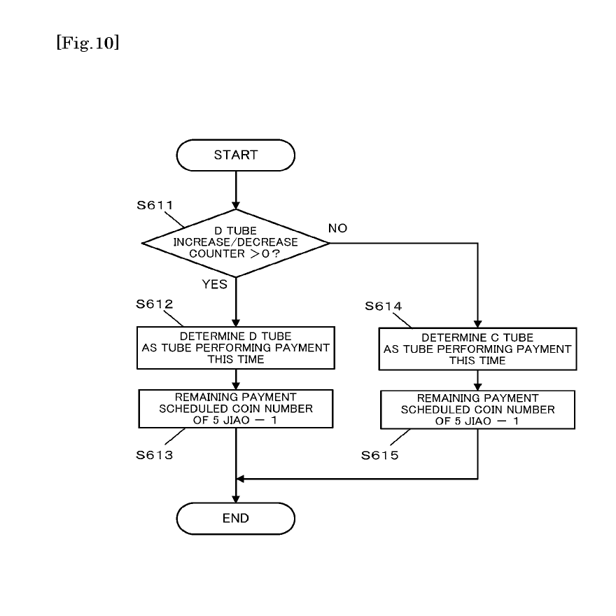

FIG. 10 is a flowchart illustrating a flow of the 5 Jiao payment tube selection processing (S504) of the coin processing apparatus 1 according to the embodiment of the present invention. In the 5 Jiao payment tube selection processing (S504), first, the coin processing apparatus 1 determines whether the value of the increase/decrease counter 91 of the D tube (5 Jiao) 64 to be the increase coin tube is larger than 0 (S611). When the value of the increase/decrease counter 91 of the D tube (5 Jiao) 64 is larger than 0, the coin processing apparatus 1 selects the D tube (5 Jiao) 64 as a coin tube performing the payment this time (S612), updates the remaining payment scheduled coin number 93 of the coins of 5 Jiao by decreasing a value thereof by 1 (S613), and ends the 5 Jiao payment tube selection processing (S504). When the value of the increase/decrease counter 91 of the D tube (5 Jiao) 64 is 0, the coin processing apparatus 1 selects the C tube (5 Jiao) 63 to be the initial replenishment coin tube as a coin tube performing the payment this time (S614), updates the remaining payment scheduled coin number 93 of the coins of 5 Jiao by decreasing a value thereof by 1 (S615), and ends the 5 Jiao payment tube selection processing (S504).

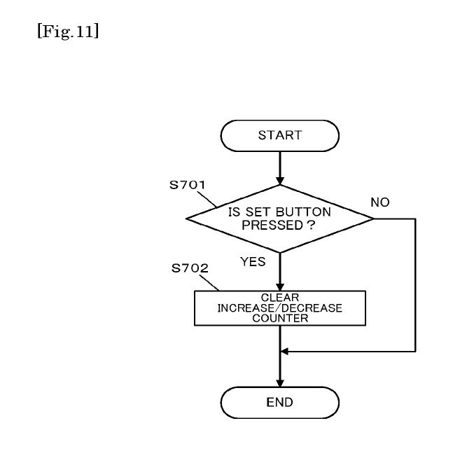

FIG. 11 is a flowchart illustrating a flow of the initial replenishment state setting processing (S104) of the coin processing apparatus according to the embodiment of the present invention. In the initial replenishment state setting processing (S104), when it is detected that the SET button to be the initial replenishment state setting unit 12 is pressed in the standby state (S701), the coin processing apparatus 1 clears the value of the increase/decrease counter 91 and sets the value to 0 (S702).

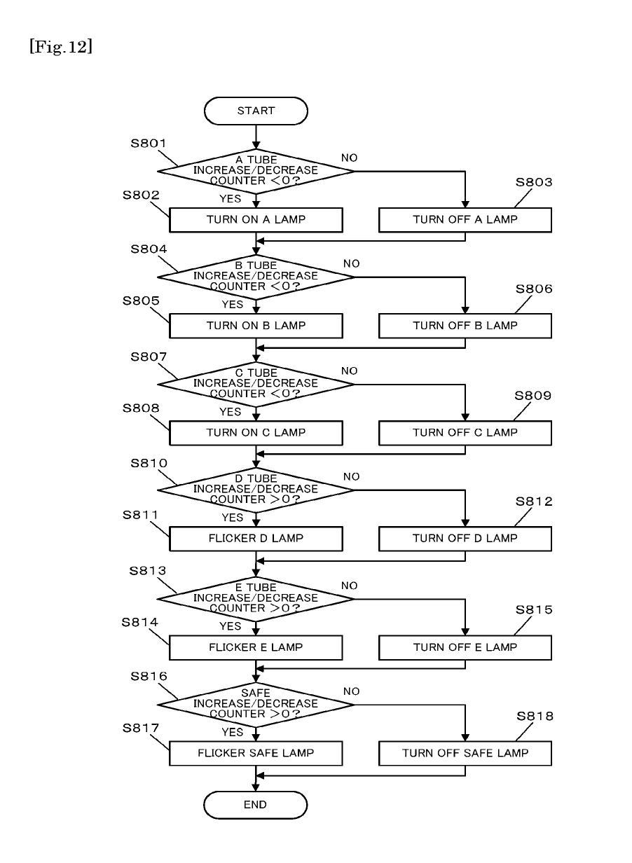

FIG. 12 is a flowchart illustrating a flow of the coin tube state display processing (S105) of the coin processing apparatus according to the embodiment of the present invention. In the coin tube state display processing (S105), first, the coin processing apparatus 1 determines whether the value of the increase/decrease counter 91 of the A tube (1 Yuan) 61 is smaller than 0 (S801). When the value is smaller than 0, the coin processing apparatus 1 turns on the A lamp 131 (S802) and when the value is 0, the coin processing apparatus 1 turns off the A lamp 131 (S803). Next, the coin processing apparatus 1 determines whether a value of the increase/decrease counter 91 of the B tube (1 Yuan) 62 is smaller than 0 (S804). When the value is smaller than 0, the coin processing apparatus 1 turns on the B lamp 132 (S805) and when the value is 0, the coin processing apparatus 1 turns off the B lamp 132 (S806). Next, the coin processing apparatus 1 determines whether a value of the increase/decrease counter 91 of the C tube (5 Jiao) 63 is smaller than 0 (S807). When the value is smaller than 0, the coin processing apparatus 1 turns on the C lamp 133 (S808) and when the value is 0, the coin processing apparatus 1 turns off the C lamp 133 (S809). Next, the coin processing apparatus 1 determines whether a value of the increase/decrease counter 91 of the D tube (5 Jiao) 64 is larger than 0 (S810). When the value is larger than 0, the coin processing apparatus 1 flickers the D lamp 134 (S811) and when the value is 0, the coin processing apparatus 1 turns off the D lamp 134 (S812). Next, the coin processing apparatus 1 determines whether a value of the increase/decrease counter 91 of the E tube (1 Yuan) 65 is larger than 0 (S813). When the value is larger than 0, the coin processing apparatus 1 flickers the E lamp 134 (S814) and when the value is 0, the coin processing apparatus 1 turns off the E lamp 134 (S815). Finally, the coin processing apparatus 1 determines whether a value of the increase/decrease counter 91 of the safe is larger than 0 (S816). When the value is larger than 0, the coin processing apparatus 1 flickers the safe lamp 136 (S817) and when the value is 0, the coin processing apparatus 1 turns off the safe lamp 136 (S818) and ends the coin tube state display processing (S105).

FIG. 13 is a schematic diagram of another embodiment of the coin tube state display unit 13 according to the present invention. In this embodiment, the coin tube state display unit 13 includes number display units 131d to 135d corresponding to the five coin tubes 61 to 65 and a safe lamp 136 corresponding to the safe. On the number display units 131d to 135d, values of the increase/decrease counters 91 of the coin tubes 61 to 65 corresponding to the number display units 131d to 135d are displayed. The safe lamp 136 is flickered when the value of the increase/decrease counter 91 of the safe is larger than 0 and is turned off when the value of the increase/decrease counter 91 of the safe is 0 or less. For the safe, a configuration in which an increase amount for each coin type is displayed can be used.

According to the coin payment device 1 according to the embodiment described above, the collection of the coins and the replenishment of the change by the manual work of the worker can be performed in short time.

The embodiment of the present invention has been described. However, the coin processing apparatus according to the present invention is not limited to the embodiment. The coin processing apparatus according to the embodiment described above has one or two initial replenishment coin tubes and one increase coin tube for each coin type. However, the coin processing apparatus may have two or more increase coin tubes for each coin type.

### REFERENCE SIGNS LIST

1 coin processing apparatus
2 coin sort device
3 coin storage device
4 coin payment device
5 coin sort unit
6 coin storage unit
61 to 65 coin tube
7 coin payment unit
8 operation unit
9 storage unit
91 increase/decrease counter
92 payment enabled coin number
93 remaining payment scheduled coin number
10 full state detection switch
11 empty switch
12 initial replenishment state setting unit
12a SET button
13 coin tube state display unit
14 main control of vending machine and like
C coin

1. A coin processing apparatus that includes a coin identification unit identifying types of input coins, a coin sort unit sorting the coins identified by the coin identification unit for each coin type, a plurality of coin tubes storing the coins sorted by the coin sort unit for each coin type, and a coin payment unit paying the coins stored in the coin tubes, the coin processing apparatus comprising:
an initial replenishment coin tube and an increase coin tube that are provided for at least one specific coin type, the initial replenishment coin tube storing coins of a predetermined initial replenishment coin number in an initial replenishment state in which work for collection of the coins and replenishment of change is performed and the increase coin tube not storing the coins in the initial replenishment state; and
an initial replenishment state setting unit that causes an apparatus body to recognize the initial replenishment state,
wherein, when the number of coins stored in the initial replenishment coin tube is smaller than the initial replenishment coin number, the coin sort unit sorts the input coins of the specific coin type into the initial replenishment coin tube and when the number of coins stored in the initial replenishment coin tube is the initial replenishment coin number, the coin sort unit sorts the input coins of the specific coin type into the increase coin tube, and
when the coins are stored in the increase coin tube, the coin payment unit pays the coins of the specific coin type from the increase coin tube and when no coin is stored in the increase coin tube, the coin payment unit pays the coins of the specific coin type from the initial replenishment coin tube.

2. The coin processing apparatus according to claim 1, wherein the initial replenishment state setting unit is an input unit provided in the apparatus body and a worker performs an input manually using the initial replenishment state setting unit.

3. The coin processing apparatus according to claim 1, further comprising:
a coin tube state display unit that displays a storage state of the coins in each of the coin tubes.

4. The coin processing apparatus according to claim 3, wherein the coin tube state display unit displays whether the coins of the initial replenishment coin number are stored in the initial replenishment coin tube and whether the coins are stored in the increase coin tube.

5. The coin processing apparatus according to claim 3, wherein the coin tube state display unit displays an increase/decrease amount of the number of stored coins from the initial replenishment state.

6. The coin processing apparatus according to claim 2, further comprising:
a coin tube state display unit that displays a storage state of the coins in each of the coin tubes.

7. The coin processing apparatus according to claim 6, wherein the coin tube state display unit displays whether the coins of the initial replenishment coin number are stored in the initial replenishment coin tube and whether the coins are stored in the increase coin tube.

8. The coin processing apparatus according to claim 6, wherein the coin tube state display unit displays an increase/decrease amount of the number of stored coins from the initial replenishment state.
